(19) United States
(12) Patent Application Publication
(10) Pub. No.: US 2013/0084458 A1
(43) Pub. Date: Apr. 4, 2013

(54) HARD COAT AGENT COMPOSITION AND HARD COAT FILM USING THE SAME

(71) Applicant: TDK Corporation, Tokyo (JP)

(72) Inventors: Chieko Yamada, Tokyo (JP); Kazushi Tanaka, Tokyo (JP)

(73) Assignee: TDK CORPORATION, Tokyo (JP)

(21) Appl. No.: 13/627,355

(22) Filed: Sep. 26, 2012

(30) Foreign Application Priority Data
Sep. 30, 2011 (JP) 2011-217833

(51) Int. Cl. C09D 133/06; C08K 5/5419; B32B 27/00; C08K 7/00; B82Y 30/00

(52) U.S. Cl. 428/421; 524/507; 524/267; 977/773

(57) ABSTRACT

A hard coat agent composition comprising: a urethane acrylate (B) having two or more (meth)acryloyl groups; a first fluorine-containing polyether compound (C) having an active energy ray reactive group via a urethane bond at each of both ends of a molecular chain containing a perfluoropolyether group; a second fluorine-containing polyether compound (D) having an active energy ray reactive group via a urethane bond at one end of a molecular chain containing a perfluoropolyether group and not having an active energy ray reactive group at the other end; and a curable compound (A) having two or more active energy ray polymerizing groups.

### BACKGROUND OF THE INVENTION

1. Field of the Invention

The present invention relates to a hard coat agent composition useful in forming on a surface of various articles a hard coat layer excellent in transparency, anti-staining property, lubricating property, solvent resistance, scratch resistance and abrasion resistance, as well as in punchability.

The present invention also relates to an article having on the surface a hard coat layer formed by using the above hard coat agent composition. Examples of articles that require provision of a surface hard coat layer include an optical information medium, an optical lens, an optical filter, an anti-reflection film and various display devices such as a touch panel, a liquid crystal display, a CRT display, a plasma display and an EL display.

In particular, the present invention relates to a hard coat film having on the surface of a transparent base material a hard coat layer formed by using the above hard coat agent composition. The hard coat film is used, for example, for protecting the surface of various display devices as described above.

2. Disclosure of the Related Art

Stains derived from various staining substances and finger prints will attach to the surface of an optical information medium, an optical lens, an optical filter, an anti-reflection film, and various display devices such as a touch panel, a liquid crystal display, a CRT display, a plasma display and an EL display, when they are used. Such attachment of stains or finger prints is undesirable and the surface of these are sometimes subjected to an appropriate surface treatment for improving anti-staining property, reducing finger-print attachment property or increasing finger-print removing property.

For the purpose of improving the scratch resistance of the surface of these, it is general practice to form a transparent and scratch-resistant hard coat on the surface. The hard coat is formed by applying to the surface an active energy ray polymerizing curable compound having two or more polymerizing functional groups such as a (meth)acryloyl group in the molecule, and allowing the compound to cure by irradiation with an active energy ray such as an ultraviolet ray. However, such a hard coat is given only for improving the scratch resistance and therefore not expected to have an anti-staining effect on dust, atmospheric oil mist or staining substances such as finger print stains.

From these viewpoints, it is demanded to form on the surface of various articles a hard coat layer having high transparency, and is excellent in anti-staining property, lubricating property, solvent resistance, scratch resistance and abrasion resistance.

For example, Japanese Laid-open Patent Publication JP-A-2005-126453 discloses a hard coat agent composition which comprises a fluorine-containing polyether compound (A) having a perfluoropolyether unit, urethane bond and active energy ray reactive group, and a curable compound (B) having two, or three or more active energy ray polymerizing groups in the molecule (claim 1). More specifically, the fluorine-containing polyether compound (A) is a compound in which a (meth)acryloyl group is introduced via urethane bond into each of hydroxyl groups of a fluorine-containing polyether compound having a hydroxyl group at each of both ends and also having a perfluoropolyether unit, and as concrete examples, compounds 1 and 2 are recited (paragraph [0058]). This publication discloses that by using the fluorine-containing polyether compound (A) having an active energy ray reactive group and a urethane bond, it is possible to obtain a hard coat agent composition capable of forming a hard coat layer excellent in anti-staining property and lubricating property while maintaining the hardness (paragraphs [0015] and [0018]).

WO03/002628 publication discloses a composition comprising a triisocyanate (A) obtained by cyclic trimerizing a diisocyanate, a perfluoropolyether (B-1) having at least one active hydrogen atom, and a monomer (B-2) having an active hydrogen atom and a carbon-carbon double bond (claim 1). Concretely, such a compound is disclosed that a hydroxyl group in one-end monohydroxyl-perfluoropolyether (PFPE-CH₂OH) and one isocyanate group in the cyclic triisocyanate compound form a urethane bond, and one or two (meth)acryloyl group(s) is/are introduced via a urethane bond derived from the other one or two isocyanate groups in the triisocyanate compound (the upper compound in page 10, or compound (2) in page 9).

Japanese Laid-open Patent Publication JP-A-2010-143092 discloses a hard coat film having a transparent base material and a hard coat layer, wherein the hard coat layer is a cured film of a curable composition containing a compound (B) having respectively one or more (meth)acryloyl group(s) at both ends of a perfluoropolyether group represented by general formula (3), a compound (C) having a perfluoropolyether group, a polysiloxane group and a (meth)acryloyl group represented by general formula (1), and a compound (D) other than the (B) component and the (C) component having two or more (meth)acryloyl groups in the molecule (claims 1, 3 and 6).
Patent Document 1: JP-A-2005-126453
Patent Document 2: WO03/002628
Patent Document 3: JP-A-2010-143092

### SUMMARY OF THE INVENTION

According to the technique disclosed in Japanese Publication JP-A-2005-126453, it is possible to form on the surface of various articles a hard coat layer excellent in anti-staining property, lubricating property, scratch resistance and abrasion resistance. However, the obtained hard coat layer is inferior in punchability. Also by the techniques disclosed in WO03/002629 publication and Japanese Publication JP-A-2010-143092, a hard coat layer excellent in punchability cannot be formed.

Good punchability is required for applying a hard coat layer to various uses, and punchability is important particularly when application to various display devices such as a touch panel and a liquid crystal display is considered.

Accordingly, an object of the present invention is to provide a hard coat agent composition useful in forming on the surface of various articles a hard coat layer excellent in transparency, anti-staining property, lubricating property, solvent resistance, scratch resistance and abrasion resistance, as well as in punchability.

Furthermore, another object of the present invention is to provide an article having on the surface a hard coat layer formed by using the above hard coat agent composition.

In particular, an object of the present invention is to provide a hard coat film having a hard coat layer formed by using the above hard coat agent composition on the surface of a transparent base material.

The present invention includes the following:

(1) A hard coat agent composition comprising:

a urethane acrylate (B) having two or more (meth)acryloyl groups within each molecule and not containing fluorine;

a first fluorine-containing polyether compound (C) having an active energy ray reactive group via a urethane bond at each of both ends of a molecular chain containing a perfluoropolyether group;

a second fluorine-containing polyether compound (D) having an active energy ray reactive group via a urethane bond at one end of a molecular chain containing a perfluoropolyether group and not having an active energy ray reactive group at the other end; and

a curable compound (A) having two, or three or more active energy ray polymerizing groups within each molecule and not containing a urethane bond and fluorine, wherein

the (C) component is contained in an amount of 0.05 to 0.7 parts by weight in relation to 100 parts by weight of a total amount of the (A) component and the (B) component, and

the (D) component is contained so that a weight ratio C/D between the (C) component and the (D) component ranges from 1/5 to 5/2.

(2) The hard coat agent composition described in the above (1), wherein the (B) component is contained in an amount of 5 to 50 parts by weight in relation to 100 parts by weight of the (A) component.

(3) The hard coat agent composition described in the above (1) or (2), wherein the curable compound (A) contains 65 to 100% by weight of a curable compound (At) having three or more active energy ray polymerizing groups within each molecule, and 0 to 35% by weight of a curable compound (Ad) having two active energy ray polymerizing groups within each in the molecule on the basis of the curable compound (A).

(4) The hard coat agent composition described in any one of the above (1) to (3) , wherein the active energy ray reactive group contained in the first fluorine-containing polyether compound (C) and/or the active energy ray reactive group contained in the second fluorine-containing polyether compound (D) are selected from the group consisting of a (meth)acryloyl group and a vinyl group.

(5) The hard coat agent composition described in any one of the above (1) to (4), wherein the active energy ray polymerizing groups contained in the curable compound (A) are selected from the group consisting of a (meth)acryloyl group and a vinyl group.

(6) The hard coat agent composition described in any one of the above (1) to (5), wherein the first fluorine-containing polyether compound (C) is a compound in which:

a (meth)acryloyl group is introduced via two urethane bonds derived from an diisocyanate compound into each of hydroxyl groups at both ends in a perfluoropolyether compound having a perfluoropolyether group and having a hydroxyl group at each of both ends.

(7) The hard coat agent composition described in the above (6), wherein the diisocyanate compound is selected from the group consisting of an aliphatic diisocyanate and an alicyclic diisocyanate.

(8) The hard coat agent composition described in any one of the above (1) to (7), wherein the second fluorine-containing polyether compound (D) is a compound in which:

one hydroxyl group in a perfluoropolyether compound having a perfluoropolyether group and having a hydroxyl group at one end or both ends, and one isocyanate group in a triisocyanate compound which is a cyclic trimer of a diisocyanate form a urethane bond; and

one or two (meth)acryloyl group(s) is/are introduced via a urethane bond derived from the other one or two isocyanate group(s) in the triisocyanate compound.

(9) The hard coat agent composition described in the above (8), wherein the diisocyanate compound forming the triisocyanate is selected from the group consisting of an aliphatic diisocyanate and an alicyclic diisocyanate.

(10) The hard coat agent composition described in any one of the above (1) to (9), further comprising inorganic fine particles (E) having an average particle diameter of 100 nm or less.

The hard coat agent composition described in the above (10), wherein the inorganic fine particles (E) are contained in an amount of 5 parts by weight or more and 200 parts by weight or less in relation to 100 parts by weight of the total amount of the (A) component and the (B) component.

(11) The hard coat agent composition described in the above (10), wherein the inorganic fine particles (E) are silica fine particles which may be surface-modified by a hydrolyzable silane compound having an active energy ray reactive group.

(12) An article provided with a hard coat layer comprising a cured substance of the hard coat agent composition described in any one of the above (1) to (11), on the surface of the article.

In the present invention, examples of articles that require provision of a surface hard coat layer include an optical information medium, an optical lens, an optical filter, an anti-reflection film, and various display devices such as a touch panel, a liquid crystal display, a CRT display, a plasma display and an EL display. Optical information media include various media such as a read-only optical disc, an optical recording disc and a magneto-optical recording disc.

(13) A hard coat film comprising a transparent base material and a hard coat layer on the transparent base material, wherein the hard coat layer comprises a cured substance of the hard coat agent composition described in any one of the above (1) to (11).

The hard coat film is used, for example, for protecting the surface of various display devices as described above.

According to the present invention, there is provided a hard coat agent composition useful in forming on the surface of various articles a hard coat layer excellent in transparency, anti-staining property, lubricating property, solvent resistance, scratch resistance and abrasion resistance as well as in punchability.

Also, according to the present invention, there is provided an article having on the surface a hard coat layer formed by using the hard coat agent composition.

In particular, according to the present invention, there is provided a hard coat film having on the surface of a transparent base material a hard coat layer formed by using the hard coat agent composition. The hard coat film of the present invention is excellent in transparency, anti-staining property, lubricating property, solvent resistance, scratch resistance and abrasion resistance, as well as in punchability. Since the hard coat layer is excellent in punchability, the hardcoat layer can be applied to various uses.

### DETAILED DESCRIPTION OF THE INVENTION

First, a hard coat agent composition of the present invention will be described.

A hard coat agent composition of the present invention comprises:

a urethane acrylate (B) having two or more (meth)acryloyl groups within each molecule and not containing fluorine;

a first fluorine-containing polyether compound (C) having an active energy ray reactive group via a urethane bond at each of both ends of a molecular chain containing a perfluoropolyether group;

a second fluorine-containing polyether compound (D) having an active energy ray reactive group via a urethane bond at one end of a molecular chain containing a perfluoropolyether group and not having an active energy ray reactive group at the other end; and

a curable compound (A) having two, or three or more active energy ray polymerizing groups within each molecule and not containing a urethane bond and fluorine. The curable compound (A) and the urethane acrylate (B) are non-fluorine components. Here, by the term (meth)acryloyl group, a methacryloyl group and an acryloyl group are collectively meant.

The curable compound (A) is other than the (B), (C) and (D) components, and has two, or three or more active energy ray polymerizing groups in the molecule, and does not have a urethane bond and a fluorine atom. The curable compound (A) is a primary component of the curable component in the hard coat agent composition, and forms the matrix of the hard coat layer obtained after curing.

The hardcoat agent composition includes as the curable compound (A), for example, 65 to 100% by weight of a curable compound (At) having three or more active energy ray polymerizing groups in the molecule, and 0 to 35% by weight of a curable compound (Ad) having two active energy ray polymerizing groups in the molecule on the basis of the curable compound (A). In other words, the bi-functional curable compound (Ad) is an optional component, and does not have to be contained.

Since the active energy ray curable compound (At) has three or more active energy ray polymerizing groups in the molecule, a hardness sufficient for a hard coat layer is obtained by itself after curing. On the other hand, by the active energy ray curable compound (Ad), it is difficult to obtain a hardness sufficient for a hard coat layer by itself after curing because the compound (Ad) has only two active energy ray polymerizing groups in the molecule. Accordingly, it is preferred to use the curable compound (At) as a primary component of the curable compound (A) and to use the curable compound (Ad) in an amount within the above-mentioned weight range, if used.

The curable compound (At) and the curable compound (Ad) may be multifunctional monomers or oligomers as far as they do not contain a urethane bond and fluorine, and have respectively three or more, or two active energy ray polymerizing groups in the molecule, and their structures are not particularly restricted. The curable compound (At) and the curable compound (Ad) do not contain a urethane bond and fluorine in order to obtain a high hardness of the hard coat layer. Active energy ray polymerizing groups contained in the curable compound (At) and the curable compound (Ad) are selected from a (meth)acryloyl group and a vinyl group.

Among these active energy ray curable compounds (At) and (Ad), examples of the compound having a (meth)acryloyl group include, but are not necessarily limited to, multifunctional (meth)acrylates such as 1,3-butanediol di(meth)acrylate, 1,4-butanediol di(meth)acrylate, 1,6-hexanediol di(meth)acrylate, neopentylglycol di(meth)acrylate, ethyleneglycol di(meth)acrylate, diethyleneglycol di(meth)acrylate, triethyleneglycol di(meth)acrylate, dipropyleneglycol di(meth)acrylate, 3-(meth)acryloyloxyglycerin mono(meth)acrylate, ethyleneoxide modified bisphenol A di(meth)acrylate; trimethylol propane tri(meth)acrylate, ditrimethylol propane tetra(meth)acrylate, pentaerythritol tri(meth)acrylate, pentaerythritol tetra(meth)acrylate, ditrimethylol propane tetra(meth)acrylate, dipentaerythritol penta(meth)acrylate, dipentaerythritol hexa(meth)acrylate, glycerin tri(meth)acrylate, epoxy acrylate and ester acrylate.

Among these, dipentaerythritol penta(meth)acrylate, dipentaerythritol hexa(meth)acrylate, pentaerythritol tri(meth)acrylate, pentaerythritol tetra(meth)acrylate, ditrimethylol propane tetra(meth)acrylate and the like are preferred.

Examples of the compound having a vinyl group include, but are not necessarily limited to, multifunctional vinyl ethers such as ethyleneglycol divinylether, pentaerythritol divinylether, 1,6-hexanediol divinylether, trimethylolpropane divinylether, ethyleneoxide modified hydroquinone divinylether, ethyleneoxide modified bisphenol A divinylether, pentaerythritol trivinylether, dipentaerythritol hexavinylether and ditrimethylolpropane polyvinylether.

In the hard coat agent composition of the present invention, only one kind or a combination of two or more kinds of active energy ray curable compounds (At) may be used. When an active energy ray curable compound (Ad) is used together, only one kind or a combination of two or more kinds of the curable compounds (Ad) may be used.

In the hard coat agent composition, as a curable component, besides the curable compound (At) and the curable compound (Ad), a monofunctional monomer having one active energy ray polymerizing group [a (meth)acryloyl group or a vinyl group] in the molecule may be used as far as a sufficient hardness for a hard coat layer is maintained.

The urethane acrylate (B) used in the present invention is a compound having two or more (meth)acryloyl groups in the molecule and not containing fluorine. As the urethane acrylate (B),

a reaction product of a polyisocyanate and (meth)acrylate having a hydroxyl group; and

a reaction product of a polyol, a polyisocyanate and (meth)acrylate having a hydroxyl group

are recited.

Examples of the (meth)acrylate having a hydroxyl group include 2-hydroxyethyl (meth)acrylate, 2-hydroxypropyl (meth) acrylate, 2-hydroxy-3-(meth)acryloyloxypropyl (meth)acrylate, 1,4-butanediol mono(meth)acrylate, pentaerythritol tri(meth)acrylate and glycerin di(meth)acrylate.

Examples of the polyisocyanate include diisocyanates such as hexamethylene diisocyanate, isophorone diisocyanate, dicyclohexylmethane diisocyanate and dicyclopentanyl diisocyanate.

Examples of the polyol include diols such as ethylene glycol, propylene glycol, neopentyl glycol, 1,4-butanediol, 1,6-hexanediol, (meth)acrylate, neopentyl glycol di(meth)acrylate, diethylene glycol and dipropylene glycol; polyester polyols which are reaction products of these diols and aliphatic dicarboxylic acids such as succinic acid, maleic acid and adipic acid or dicarboxylic acid anhydrides; polyetherpolyols; and polycarbonate diols.

In the present invention, as a preferred urethane acrylate (B), a reaction product of hydroxyl group-containing (meth)acrylate selected from 2-hydroxyethyl (meth)acrylate, 2-hydroxypropyl (meth)acrylate, 2-hydroxybutyl (meth)acrylate and pentaerythritol tri(meth)acrylate; and a diisocyanate selected from hexamethylene diisocyanate and isophorone diisocyanate is recited. When pentaerythritol tri(meth)acrylate is used as the hydroxyl group-containing (meth)acrylate, PET-HDI-PET which is urethane acrylate having two urethane bonds and six (meth)acryloyl groups in the molecule is obtained. Here, HDI represents hexamethylene diisocyanate, and PET represents pentaerythritol tri(meth)acrylate.

In the hard coat agent composition of the present invention, only one kind or a combination of two or more kinds of urethane acrylates (B) may be used.

In the hard coat agent composition of the present invention, by using the urethane acrylate (B), a hard coat layer excellent in punchability is obtained. The curable compound (A) which is a primary component in the hard coat agent composition forms the matrix of the hardcoat layer to give hardness of the hardcoat layer. However, the curable compound (A) gives insufficient punchability of the hardcoat layer. It is supposed that by using the urethane acrylate (B), appropriate toughness is given to the hard coat layer, and the punchability (or punching quality) of the hard coat layer is improved. In the present invention, the wording “excellent in punchability” means that punching that leads neither crack nor burr in the punched edge is enabled.

The urethane acrylate (B) component may be used, for example, in an amount of about 5 to 50 parts by weight, preferably about 10 to 30 parts by weight in relation to 100 parts by weight of the curable compound (A) component. When the amount of the urethane acrylate (B) is less than 5 parts by weight, the effect of adding the (B) component is small, and the effect of improving the punchability is difficult to be obtained. On the other hand, when the amount of the urethane acrylate (B) exceeds 50 parts by weight, the hard coat layer can be softened, and the effect of improving the punchability is sufficiently obtained by addition of up to 50 parts by weight.

The first fluorine-containing polyether compound (C) is used for imparting anti-staining property and lubricating property to the surface of the hard coat layer. The first fluorine-containing polyether compound (C) is a compound having an active energy ray reactive group via a urethane bond at each of both ends of a molecular chain containing a perfluoropolyether group.

In the first fluorine-containing polyether compound (C), the perfluoropolyether group includes, for example, a perfluoropolyether unit represented by —[CF₂O]—, —[CF₂CF₂O]—, —[CF₂CF₂CF₂O]—, —[CF(CF₃)CF₂O]— or the like. The perfluoropolyether group may be composed of one kind of perfluoropolyether unit, or may be composed of two or more kinds of perfluoropolyether units. When it is composed of two or more kinds of perfluoropolyether units, each of the perfluoropolyether units may be arranged in random or block form.

An active energy ray reactive group is introduced via a urethane bond at each of both ends of a molecular chain containing the perfluoropolyether group. As the active energy ray reactive group, a (meth)acryloyl group and a vinyl group are recited. Perfluoropolyether moieties tend to concentrate in the surface of the hard coat layer, and excellent anti-staining property and lubricating property are imparted to the surface of the hard coat layer. On the other hand, by having an active energy ray reactive group at each of the both ends of the molecular chain, a crosslinking reaction between the first fluorine-containing polyether compounds (C) itself; and a crosslinking reaction between the first fluorine-containing polyether compound (C), and the active energy ray curable compounds (At) and (Ad), the urethane acrylate (B) and/or the second fluorine-containing polyether compound (D) occur by irradiation with an active energy ray at the time of allowing the hard coat to cure, so that immobilization into the hard coat layer is improved. As a result, a hard coat layer having very excellent anti-staining property and lubricating property under various storage conditions and use conditions is formed.

The first fluorine-containing polyether compound (C) preferably has a number average molecular weight Mn in terms of polystyrene measured by GPC (gel permeation chromatography) of 500 or more and 10,000 or less. By using a compound (C) having a number average molecular weight within this range, compatibility with other components (A) and (B) in the presence of the second fluorine-containing polyether compound (D) tends to be good in the hard coat agent composition, and desired water repellency and/or lubricating property can be imparted to the surface of the hard coat layer. When the number average molecular weight Mn is less than 500, the effect of improving the anti-staining property and lubricating property tends to be weakened.

The first fluorine-containing polyether compound (C) is preferably obtained from a perfluoropolyether compound having a perfluoropolyether group and having a hydroxyl group at each of both ends as a starting material, by introducing a (meth)acryloyl group via two urethane bonds derived from a diisocyanate compound into each hydroxyl group at both ends. The first fluorine-containing polyether compound (C) is excellent in immobilization into the hardcoat layer, and a hard coat layer having very excellent solvent resistance is obtained.

Examples of the perfluoropolyether compound containing diols at both ends as a starting material include, but of course not limited to, the following compounds.

HOCH₂—CF₂O—[CF₂CF₂O]l-[CF₂O]m-CF₂CH₂OH (Z DOL)

HO(CH₂CH₂O)n-CH₂—CF₂O—[CF₂CF₂O]l-[CF₂O]m-CF₂CH₂(OCH₂CH₂)nOH (Zdol-TX)

HOCH₂CH(OH)CH₂O—CH₂—CF₂O—[CF₂CF₂O]l-[CF₂O]m-CF₂CH₂OCH₂CH(OH)CH₂OH (Z-Tetraol)

The diisocyanate compound for use in preparing the first fluorine-containing polyether compound (C) may be selected from the group consisting of an aliphatic diisocyanate and an alicyclic diisocyanate. Examples of the aliphatic diisocyanate include hexamethylene diisocyanate and the like. Examples of the alicyclic diisocyanate include isophorone diisocyanate, dicyclohexylmethane diisocyanate and dicyclopentanyl diisocyanate and the like.

In synthesis of the first fluorine-containing polyether compound (C), first, a terminal hydroxyl group in the perfluoropolyether compound containing hydroxyl groups at both ends which is the above-mentioned starting material is reacted with one isocyanate group in the diisocyanate compound to generate a urethane bond [perfluoropolyether compound binding step]. Then, a hydroxyl group in a compound having an active energy ray reactive group and the hydroxyl group is reacted with the other isocyanate group in the diisocyanate compound, to introduce the active energy ray reactive group via a urethane bond [active energy ray reactive group introducing step]. These reactions may be conducted in any order. In other words, it is possible to conduct the active energy ray reactive group introducing step first, and then conduct the perfluoropolyether compound binding step.

As the compound having an active energy ray reactive group and a hydroxyl group, hydroxyl group-containing (meth)acrylate or a hydroxyl group-containing vinyl compound may be used. For example, 2-hydroxyethyl (meth)acrylate, 3-hydroxypropyl (meth)acrylate, 3-hydroxybutyl (meth)acrylate, pentaerythritol tri(meth)acrylate, allyl alcohol, and the like are recited. When monofunctional acrylate is used, as shown in the following chemical structural formula 1, one acrylate is introduced at each of both ends of the molecule. When multifunctional acrylate is used, plural acrylates are introduced at each of both ends of the molecule. When trifunctional acrylate is used as the multifunctional acrylate, as shown in the following chemical structural formula 2, three acrylates are introduced at each of both ends of the molecule.

As concrete examples of the first fluorine-containing polyether compound (C), those represented by the following chemical structural formula 1 or 2 are recited, and likewise various kinds of fluorine-containing polyether compounds (C) may be used.

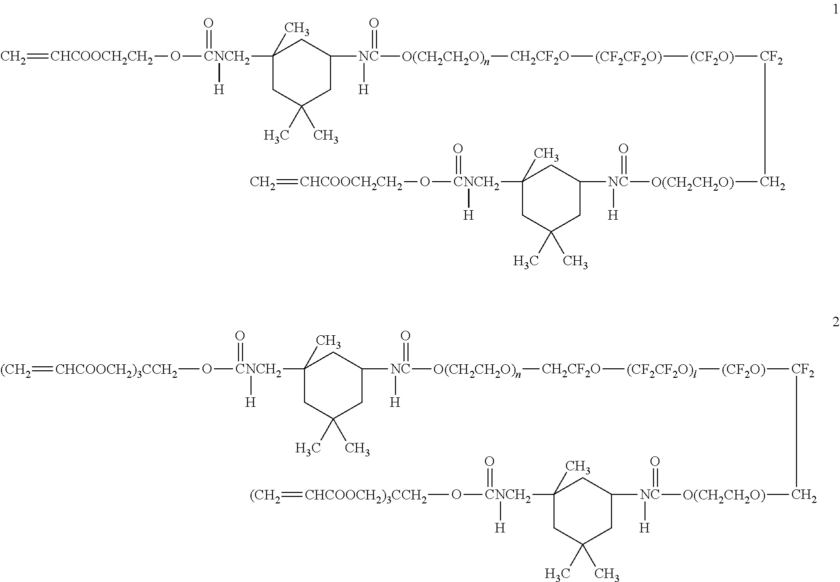

As concrete examples of the first fluorine-containing polyether compound (C), the following compounds are recited.

CH₂═C(CH₃)—COO—CH₂CH₂—NHCO—OCH₂—CF₂O—[CF₂CF₂O]l-[CF₂O]m-CF₂CH₂O—CONH—CH₂CH₂—OCO—C(CH₃)═CH₂

The compound obtained by introducing a methacryloyl group (MOI modification) via a urethane bond by causing methacryloyloxyethyl isocyanate to react with a terminal hydroxyl group of Fomblin Z DOL (alcohol modified perfluoropolyether (made by SOLVAY SOLEXIS)).

As the first fluorine-containing polyether compound (C) contained in the hard coat agent composition, only one kind or a combination of two or more kinds may be used.

In the hard coat agent composition of the present invention, the (C) component is contained in an amount of 0.05 to 0.7 parts by weight in relation to 100 parts by weight of the total amount of the (A) component and the (B) component. When the amount of the first fluorine-containing polyether compound (C) is more than 0.7 parts by weight, compatibility between the (C) component, and the (A) component and the (B) component decreases. Accordingly, the transparency of the hard coat layer decreases. On the other hand, when the amount of the first fluorine-containing polyether compound (C) is less than 0.05 parts by weight, the effect of improving the lubricating property is weak. The (C) component is contained preferably in an amount of 0.1 to 0.5 parts by weight, and more preferably in an amount of 0.2 to 0.4 parts by weight in relation to 100 parts by weight of the total amount of the (A) component and the (B) component.

The second fluorine-containing polyether compound (D) is used mainly for improving the compatibility between the (C) component, and the (A) and (B) components. The second fluorine-containing polyether compound (D) is a compound having an active energy ray reactive group via a urethane bond at one end of a molecular chain containing a perfluoropolyether group and not having an active energy ray reactive group at the other end.

Likewise the description for the first fluorine-containing polyether compound (C), in the second fluorine-containing polyether compound (D), the perfluoropolyether group includes, for example, a perfluoropolyether unit represented by —[CF₂O]—, —[CF₂CF₂O]—, —[CF₂CF₂CF₂O]—, —[CF(CF₃)CF₂O]— or the like. The perfluoropolyether group may be composed of one kind of perfluoropolyether unit, or may be composed of two or more kinds of perfluoropolyether units. When it is composed of two or more kinds of perfluoropolyether units, each of the perfluoropolyether units may be arranged in random or block form.

An active energy ray reactive group is introduced via a urethane bond at one end of a molecular chain containing the perfluoropolyether group, and there is no active energy ray reactive group at the other end. As the active energy ray reactive group, a (meth)acryloyl group and a vinyl group are recited.

While compatibility of the first fluorine-containing polyether compound (C) with the (A) and (B) components is insufficient, compatibility between the (C) component, and the (A) and (B) components is improved by using the second fluorine-containing polyether compound (D), and also the (D) component has good compatibility with the components (A), (B) and (C). The first fluorine-containing component (C) has poor compatibility with the non-fluorine components (A) and (B). The second fluorine-containing polyether compound (D) is a fluorine-containing component, and hence has good compatibility with the first fluorine-containing component (C). Further, the second fluorine-containing polyether compound (D) has a non-fluorine moiety via a urethane bond on the one end side in the perfluoropolyether group. This non-fluorine moiety contributes to compatibility with the non-fluorine components (A) and (B). Therefore, it is considered that by using the second fluorine-containing polyether compound (D) together with the first fluorine-containing polyether compound (C), compatibility among the components (A), (B), (C) and (D) is improved.

Further, perfluoropolyether moieties tend to concentrate in the surface of the hard coat layer, and the second fluorine-containing polyether compound (D) also contributes to auxiliary impartation of anti-staining property and lubricating property to the surface of the hard coat layer. On the other hand, by having an active energy ray reactive group at the above-mentioned one end of the molecular chain, a crosslinking reaction between the second fluorine-containing polyether compounds (D) itself; and a crosslinking reaction between the second fluorine-containing polyether compound (D), and the active energy ray curable compounds (At) and (Ad), the urethane acrylate (B) and/or the first fluorine-containing polyether compound (C) occur by irradiation with an active energy ray at the time of allowing the hard coat to cure, so that immobilization into the hard coat layer is improved. As a result, by using the second fluorine-containing polyether compound (D) together with the first fluorine-containing polyether compound (C), a hard coat layer having excellent compatibility and very excellent anti-staining property and lubricating property under various storage conditions and use conditions is formed.

The second fluorine-containing polyether compound (D) is preferably a compound in which: one hydroxyl group in a perfluoropolyether compound having a perfluoropolyether group and having a hydroxyl group at one end or both ends, and one isocyanate group in a triisocyanate compound which is a cyclic trimer of a diisocyanate form a urethane bond; and one or two (meth)acryloyl group(s) is/are introduced via a urethane bond derived from the other one or two isocyanate group(s) in the triisocyanate compound.

Examples of the perfluoropolyether compound containing a hydroxyl group at one end or at both ends as a starting material include, but of course not limited to, the following compounds. It is preferred to use the perfluoropolyether compound containing a hydroxyl group at one end for synthesis of the fluorine-containing polyether compound (D).

F—[CF₂CF₂CF₂O]l-CF₂CF₂CH₂OH (Demnum-SA)

F—[CF(CF₃)CF₂O]l-CF(CF₃)CH₂OH (Krytox-OH)

HOCH₂—CF₂O—[CF₂CF₂O]l-[CF₂O]m—CF₂CH₂OH (Z DOL)

HO(CH₂CH₂O)n-CH₂—CF₂O—[CF₂CF₂O]l-[CF₂O]m-CF₂CH₂(OCH₂CH₂)nOH (Zdol-TX)

HOCH₂CH(OH)CH₂O—CH₂—CF₂O—[CF₂CF₂O]l-[CF₂O]m-CF₂CH₂OCH₂CH(OH)CH₂OH (Z-Tetraol)

The triisocyanate as a starting material is a cyclic trimer of a diisocyanate, and has an isocyanurate ring. The diisocyanate compound may be selected from the group consisting of an aliphatic diisocyanate and an alicyclic diisocyanate. Examples of the aliphatic diisocyanate include hexamethylene diisocyanate and the like. Examples of the alicyclic diisocyanate include isophorone diisocyanate, dicyclohexylmethane diisocyanate and dicyclopentanyl diisocyanate and the like. As examples of the triisocyanate, cyclic trimers of hexamethylene diisocyanate and cyclic trimers of isophorone diisocyanate are shown below.

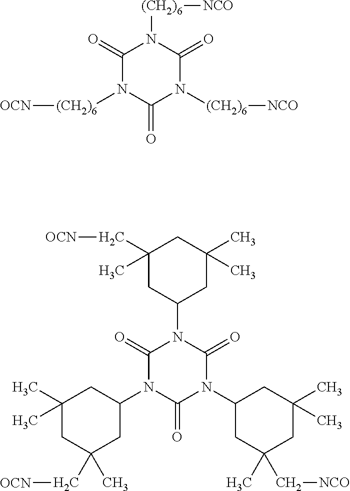

In synthesis of the second fluorine-containing polyether compound (D), first, one hydroxyl group in the perfluoropolyether compound containing a hydroxyl group at one end or at both ends is reacted with one isocyanate group in the triisocyanate compound to form a urethane bond [perfluoropolyether compound binding step]. Then, a hydroxyl group in a compound having an active energy ray reactive group and the hydroxyl group is reacted with the other one or two isocyanate groups in the triisocyanate compound, to introduce one or two active energy ray reactive group (s) via a urethane bond [active energy ray reactive group introducing step]. These reactions may be conducted in any order. In other words, it is possible to conduct the active energy ray reactive group introducing step first and then conduct the perfluoropolyether compound binding step.

As the compound having an active energy ray reactive group and a hydroxyl group, hydroxyl group-containing (meth)acrylate, or a hydroxyl group-containing vinyl compound may be used. For example, 2-hydroxyethyl (meth)acrylate, 3-hydroxypropyl (meth)acrylate, 3-hydroxybutyl (meth)acrylate, pentaerythritol tri(meth)acrylate, allyl alcohol and the like are recited. By the non-fluorine moiety introduced at the time of introduction of the active energy ray reactive group, compatibility with the non-fluorine components (A) and (B) is improved.

Preferably, an active energy ray reactive group is introduced via a urethane bond to each of the other two isocyanate groups in the triisocyanate compound. By introducing two active energy ray reactive groups, immobilization of the second fluorine-containing polyether compound (D) into the hard coat layer is further improved, and compatibility with the non-fluorine components (A) and (B) tends to improve by the introduced non-fluorine moiety.

The second fluorine-containing polyether compound (D) has neither a silicone-based group nor a Si atom. A silicone-based group does not contribute to improvement in compatibility of the first fluorine-containing polyether compound (C). Also, the first fluorine-containing polyether compound (C) has neither a silicone-based group nor a Si atom.

Concrete examples of the second fluorine-containing polyether compound (D) include those represented by the following chemical structural formula 3. PFPE represents a perfluoropolyether group. Various fluorine-containing polyether compounds (D) may be used without limited to those represented by chemical structural formula 3.

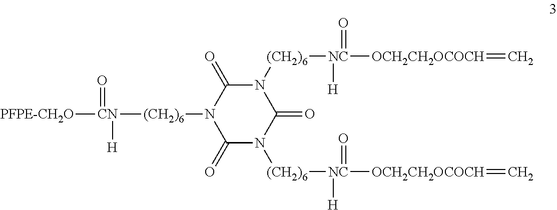

As the second fluorine-containing polyether compound (D) contained in the hard coat agent composition, only one kind or a combination of two or more kinds may be used.

In the hard coat agent composition of the present invention, the (D) component is contained so that a weight ratio C/D between the (C) component and the (D) component falls within the range of 1/5 to 5/2. When the weight ratio C/D is greater than 5/2, the amount of the (D) component is small in comparison with the (C) component, so that compatibility of the first fluorine-containing polyether compound (C) in the hard coat agent composition is insufficient. On the other hand, when the weight ratio C/D is smaller than 1/5, the amount of the (D) component is large in comparison with the (C) component, so that expression of anti-staining property, lubricating property, and solvent resistance by the first fluorine-containing polyether compound (C) can be weakened. The weight ratio C/D is preferably 1/5 to 5/3, and more preferably 2/5 to 5/3.

The hard coat agent composition of the present invention may comprise inorganic fine particles (E) having an average particle diameter of 100 nm or less as is necessary. The average particle diameter of the inorganic fine particles (E) is 100 nm or less, and preferably 20 nm or less for ensuring the transparency of the hard coat layer, and is preferably 5 nm or more because of restriction in production of a colloid solution.

The inorganic fine particles (E) are, for example, fine particles of a metal (or semi-metal) oxide, or fine particles of a metal (or semi-metal) sulfide. Examples of metals or semi-metals for inorganic fine particles include Si, Ti, Al, Zn, Zr, In, Sn, Sb, and the like. In addition to oxides and sulfides, selenides, tellurides, nitrides and carbides may be used as well. Examples of inorganic fine particles include fine particles of silica, alumina, zirconia, titania, and the like, among which silica fine particles are preferable. By adding these inorganic fine particles to the hard coat agent composition, the effect of preventing the hard coat film from curling can be imparted. Further, it is possible to further increase abrasion resistance of the hard coat layer.

Of the silica fine particles, preferably used are those surface-modified with a hydrolyzable silane compound having an active energy ray reactive group, for example, a (meth)acryloyl group-containing silane coupling agent such as γ-(meth)acryloyloxypropyl trimethoxysilane and the like, or a vinyl group-containing silane coupling agent such as vinyltriethoxysilane and the like. These reactive silica fine particles will be immobilized into a polymer matrix through a crosslinking reaction caused by irradiation with an active energy ray at the time of allowing the hard coat to cure. Examples of such reactive silica fine particles include the reactive silica particles described in Japanese Laid-open Patent Publication JP-A-9-100111 (1997), which can be favorably used in the present invention.

When the inorganic fine particles (E) are used in the hardcoat agent composition of the present invention, the inorganic fine particles (E) are contained preferably in an amount of 5 parts by weight or more to 200 parts by weight or less, and more preferably in an amount of 20 parts by weight or more to 150 parts by weight or less, in relation to 100 parts by weight of the total amount of the (A) component and the (B) component. When the inorganic fine particles (E) are contained in an amount exceeding 200 parts by weight, the film strength of the hard coat layer tends to be weak. On the other hand, when the amount of the inorganic fine particles (E) is less than 5 parts by weight, the effect of preventing the hard coat film from curling by addition of the inorganic fine particles (E) is difficult to be obtained, and the effect of improving the abrasion resistance of the hard coat layer is weak.

The hard coat agent composition of the present invention may also comprise a known photopolymerization initiator. The photopolymerization initiator is not particularly required when an electron ray is used as an active energy ray, but is required when an ultraviolet ray is used. The photopolymerization initiator may be appropriately selected from those typically used, including acetophenone based, benzoin based, benzophenone based and thioxanthone based photopolymerization initiators. Of photopolymerization initiators, examples of photoradical initiators include, for example, Darocure 1173, Irgacure 651, Irgacure 184 and Irgacure 907 (each of which is produced by Ciba Specialty Chemicals). The photopolymerization initiator is contained, for example, in an amount of about 0.5 to 5% by weight in relation to the sum of the (A), (B), (C), (D) and (E) components in the hard coat agent composition.

The hard coat agent composition of the present invention may also comprise non-polymerizing diluting solvents, organic fillers, polymerization inhibitors, antioxidants, ultraviolet ray absorbing agents, light stabilizers, antifoaming agents and leveling agents as is necessary.

The hard coat agent composition may be manufactured by mixing the above-mentioned components by an ordinary method. It is desirable to prepare the hard coat agent composition to have a viscosity suited for application using a non-reactive diluting organic solvent. Examples of the non-reactive diluting organic solvent include, but not particularly limited to, propylene glycol monomethyl ether acetate, propylene glycol monomethyl ether, ethylene glycol monomethyl ether, butyl acetate, methyl ethyl ketone, methyl isobutyl ketone, isopropyl alcohol, and the like. In this manner, the hard coat agent composition of the present invention is formed.

A hard coat layer is formed on the surface of a target article by using the hard coat agent composition of the present invention. The articles to the surface of which impartation of the hard coat layer is required include an optical information medium, an optical lens, an optical filter, an anti-reflection film, and various display devices such as a touch panel, a liquid crystal display, a CRT display, a plasma display and an EL display, and the like.

In particular, a hard coat film comprising a transparent base material and a hard coat layer on the transparent base material can be produced by using the hard coat agent composition of the present invention. The hard coat film is used, for example, for protecting the surface of various display devices as described above. As the transparent base material, various resin films or sheets used for optical uses may be used. For example, a film or sheet of a resin selected from the group consisting of polyethylene terephthalate (PET), polybutylene terephthalate, polyethylene naphthalate, polycarbonate, polymethacrylate, polystyrene, polyolefin, triacetyl cellulose and so on is used.

The hard coat agent composition is applied to the surface of a target article (or transparent base material) to form an uncured hard coat layer, and then the uncured layer is irradiated with an active energy ray such as an ultraviolet ray, an electron ray or visible light to be cured to give a hard coat layer.

For coating, various coating methods including, but not limited to, a spin coating method, a dip coating method, a gravure coating method, a roll coating method, a flow coating method and a spray coating method may be used.

When the hard coat agent composition contains a non-reactive diluting organic solvent, the hard coat agent composition is applied to form an uncured hard coat layer, and then the non-reactive organic solvent is removed by drying under heating, and then the uncured layer is irradiated with an active energy ray to be cured to form a hard coat layer. By applying the hard coat agent composition using the diluting organic solvent, and removing the organic solvent by drying under heating, the first and second fluorine-containing polyether compounds (C) and (D) are more likely to concentrate in the vicinity of the surface of the uncured hard coat layer, and thus, a larger amount of fluorine-containing polyethers is present in the vicinity of the surface of the cured hard coat layer, so that a greater effect of improving the anti-staining property and lubricating property is more likely to be obtained. The temperature at which the drying under heating is conducted is preferably 40° C. or more and 100° C. or less, for example. The time during which drying under heating is conducted is, for example, 30 seconds or more and 8 minutes or less, preferably 1 minute or more and 5 minutes or less, and more preferably 3 minutes or more and 5 minutes or less. The active energy ray may be appropriately selected from active energy rays such as an ultraviolet ray, an electron ray and visible light, and preferably, an ultraviolet ray or an electron ray is used. The film thickness of the cured hard coat layer may be appropriately determined according to the purpose, and is generally about 0.5 to 20 μm.

In this manner, an article having on the surface a hard coat layer comprising a cured product of the hard coat agent composition of the present invention is obtained. Also a hard coat film comprising a transparent base material and a hard coat layer on the transparent base material, in which the hard coat layer comprises a cured product of the hard coat agent composition of the present invention is obtained. The formed hard coat layer is excellent in transparency, anti-staining property, lubricating property, solvent resistance, scratch resistance and abrasion resistance, as well as in punchability.

### EXAMPLES

The present invention will be described more specifically by referring to the following examples, which are, however, not interpreted to restrict the present invention.

### Synthetic Example of Fluorinated Urethane Acrylate 20

As the first fluorine-containing polyether compound (C), fluorinated urethane acrylate 2 represented by the chemical structural formula 2 was synthesized in the following manner.

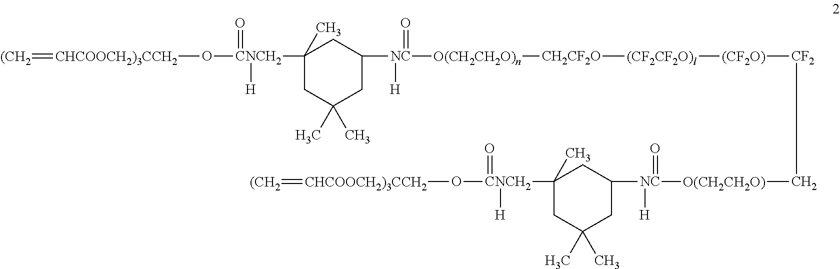

Isophorone diisocyanate (85.0 mL, 0.401 mol) and dibutyl tin dilaurate (0.2 g) were placed into a three-neck flask equipped with an agitator and a Dimroth condenser, which was heated up to 70° C. under a nitrogen gas stream. Then, 210.0 g (approximately 0.17 mol) of perfluoropolyether diol (Fomblin Z DOL TX1000 made by SOLVAY SOLEXIS) was slowly added thereto, and the reaction mixture was heated at 70° C. under a nitrogen gas stream for 4 hours. Thereafter, dibutylhydroxy toluene (0.25 g) and 239.5 g of pentaerythritol triacrylate (PET-30 made by Nippon Kayaku Co., Ltd., average functional group number of 3.4) were added to the reaction mixture and the mixture was allowed to react for another 4 hours. Fluorinated urethane acrylate 2 was obtained in this manner.

### Synthetic Example of Fluorinated Urethane Acrylate 3

As the second fluorine-containing polyether compound (D), fluorinated urethane acrylate 3 represented by the chemical structural formula 3 was synthesized. PFPE represents a F—[CF₂CF₂CF₂O]l-CF₂CF₂— group.

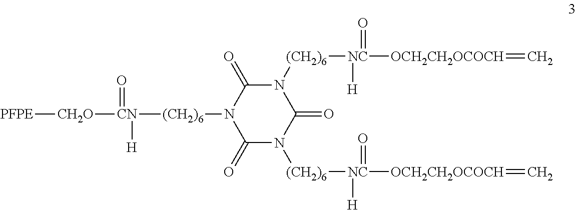

In a three-neck flask equipped with an agitator and a Dimroth condenser, 70 g of a cyclic trimer of hexamethylene diisocyanate (SUMIDUR N3300 made by Sumika Bayer Urethane Co., Ltd.) was dissolved in 200 g of 1,1,2,2,3,3,4-heptafluorocyclopentane, and added with dibutyl tin dilaurate (0.4 g), which was heated up to 45° C. under a nitrogen gas stream. Then a solution of 290 g of perfluoropolyether monool (Demnum-SA made by DAIKIN INDUSTRIES, Ltd.) dissolved in 190 g of 1,1,2,2,3,3,4-heptafluorocyclopentane was slowly added, and the reaction mixture was allowed to react at a room temperature under a nitrogen gas stream for 6 hours. Then, 29 g of 2-hydroxyethyl acrylate (HEA made by OSAKA ORGANIC CHEMICAL INDUSTRY LTD.) was added to the reaction mixture, and the mixture was allowed to react at a room temperature for another 3 hours. Fluorinated urethane acrylate 3 was obtained in this manner.

In examples and comparative examples, the following components were used.

### [Curable Component A]

DPHA: Dipentaerythritol hexaacrylate

### [Urethane Acrylate Component B]

A 1:2 addition product PET-HDI-PET of hexamethylene diisocyanate HDI and pentaerythritol triacrylate PET (PET-30 made by Nippon Kayaku Co., Ltd., average functional group number of 3.4).

### [First Fluorine-Containing Polyether Component C]

Fluorinated urethane acrylate 2 (the chemical structural formula 2) synthesized in the above.

### [Second Fluorine-Containing Polyether Component D]

Fluorinated urethane acrylate 3 (the chemical structural formula 3) synthesized in the above.

### [Reactive Silica Microparticles E]

Reactive group-modified colloidal silica (dispersion medium: propylene glycol monomethyl ether acetate, non-volatile content: 40% by weight, surface-modified with γ-methacryloyloxypropyltrimethoxysilane)

### [Polysiloxane-Containing Fluorine Acrylate Component F (Comparison)]

Polysiloxane-containing fluorine acrylate component F synthesized in the following manner was used.

Dibutylhydroxytoluene (0.072 g), 72 g of polydimethylsiloxane monool (Silaplane FM0411 made by CHISSO Corporation), 16 g (0.072 mol) of isophorone diisocyanate, 0.24 g of dibutyl tin dilaurate and 88 g of methyl ethyl ketone were added in a three-neck flask equipped with an agitator and a Dimroth condenser, and stirred at a room temperature under a nitrogen gas stream for 2 hours. Then, 108 g of methyl ethyl ketone and 108 g of perfluoropolyether diol (Fluorolink D10H made by SOLVAY SOLEXIS) were slowly added, and the mixture was heated up to 60° C. under a nitrogen gas stream, and allowed to react for 2 hours. The reaction mixture was cooled to a room temperature, and a solution of 36 g (0.072 mol) of a cyclic trimer of hexamethylene diisocyanate (SUMIDUR N3300 made by Sumika Bayer Urethane Co., Ltd.) dissolved in 36 g of methyl ethyl ketone was added to the reaction mixture, which was stirred at a room temperature in a nitrogen gas stream for 2 hours. Then, a solution of 47 g of pentaerythritol triacrylate (PET-30 made by Nippon Kayaku Co., Ltd., average functional group number of 3.4) dissolved in 47 g of methyl ethyl ketone was added, and the mixture was heated up to 60° C. under a nitrogen gas stream and allowed to react for 4 hours. Polysiloxane-containing fluorine acrylate component F was obtained in this manner.

### Example 1

As a transparent base material, a polyethylene terephthalate (PET) film having a thickness of 75 μm (Product name: COSMOSHINE A-4300 made by TOYOBO CO., LTD.) was used.

(Composition of hard coat agent)

| | |
|---|---|
| A component: | |
| Dipentaerythritol hexaacrylate | 80 parts by weight |
| B component: | |
| Urethane acrylate PET-HDI-PET | 20 parts by weight |
| C component: | |
| Fluorinated urethane acrylate 2 | 0.05 parts by weight |
| D component: | |
| Fluorinated urethane acrylate 3 | 0.02 parts by weight |
| Non-reactive diluting solvent: | |
| Propylene glycol monomethyl ether acetate | 100 parts by weight |
| Photopolymerization initiator: | |
| 1-hydroxycyclohexyl phenyl ketone | 5 parts by weight |

The ultraviolet ray/electron ray curable hard coat agent with the foregoing composition was applied to the surface of the transparent base material by a spin coating method to give a coating film, which was heated at 60° C. for 3 minutes in atmosphere to remove the diluting solvent inside the film. Then, irradiation with an ultraviolet ray was effected under conditions of an irradiation intensity of 80 W/cm; a distance from the lamp of 10 cm; and an integrated light volume of 500 mJ/cm² to form a hard coat layer having a thickness of 10 μm after curing.

### Example 2

A hard coat layer having a thickness of 10 μm after curing was formed in the same manner as in Example 1 except that a hard coat agent further containing 30 parts by weight of reactive group modified colloidal silica E component (dispersion medium: propylene glycol monomethyl ether acetate, non-volatile content: 40% by weight, surface-modified with γ-methacryloyloxypropyltrimethoxysilane) was used.

(Composition of hard coat agent)

| | |
|---|---|
| A component: | |
| Dipentaerythritol hexaacrylate | 80 parts by weight |
| B component: | |
| Urethane acrylate PET-HDI-PET | 20 parts by weight |
| C component: | |
| Fluorinated urethane acrylate 2 | 0.05 parts by weight |
| D component: | |
| Fluorinated urethane acrylate 3 | 0.02 parts by weight |
| E component: | |
| Reactive group modified colloidal | 30 parts by weight |
| silica (dispersion medium: | |
| propylene glycol monomethyl | |
| ether acetate, non-volatile content: | |
| 40% by weight, surface-modified with | |
| γ-methacryloyloxypropyltrimethoxysilane) | |
| Non-reactive diluting solvent: | |
| Propylene glycol monomethyl ether acetate | 100 parts by weight |
| Photopolymerization initiator: | |
| 1-hydroxycyclohexyl phenyl ketone | 5 parts by weight |

### Examples 3 to 10

Hard coat layers having a thickness of 10 μm after curing were formed in the same manner as in Example 1 except that hard coat agents having respective blending compositions of C, D, E components as shown in Table 1 were used.

### Comparative Examples 1 to 14

Hard coat layers having a thickness of 10 μm after curing were formed in the same manner as in Example 1 except that hard coat agents having respective blending compositions of components as shown in Table 1 were used. For some cases in comparative examples, an operation for forming a coating film was not conducted because the compatibility was poor and a uniform hardcoat agent was not obtained (Comparative Examples 2, 3, 10, and 11). Or, other film evaluations except for appearance were not conducted because a fine protrusion was observed on the surface of the coating film although a coating film was formed (Comparative Examples 4 and 5).

### [Evaluation of Hard Coat Film Sample]

For each of the hard coat film samples prepared in Examples 1 to 9 and Comparative Examples 1 to 14, the performance tests shown below were conducted.

### (Appearance)

The appearance of a hard coat film was visually checked.

ο: Appearance was good.

X: Compatibility was poor, and a fine protrusion or whitening or white turbidity was observed on the surface of the coating film.

### (Haze Value)

As a test for transparency, a haze value of the hard coat surface of a hard coat film was measured by a haze meter TC-HIII DPK (available from Tokyo Denshoku Co., Ltd.). A lower haze value indicates better transparency.

(Evaluation of Anti-Staining Property and Durability of that Property: Contact Angle)

The contact angle (deg) was measured for the hard coat surface of a hard coat film. Pure water or triolein was used as a measurement liquid, and a contact angle meter model LA-X made by Kyowa Interface Science Co., Ltd. was used to measure the static contact angle. The measurement was made in an environment of 20° C. and a relative humidity of 60%. First, an initial contact angle of the surface of a hard coat was measured.

Then, as evaluation of anti-staining durability (scratch resistance), a steel wool resistance test was conducted.

An initial hard coat surface was rubbed back and forth 500 times with a steel wool (#0000) at a load of 500 g/cm². Then, the contact angle was measured by using pure water under the same conditions as described above.

Further, as evaluation of anti-staining durability (scratch resistance), a denim resistance test was conducted.

An initial hardcoat surface was rubbed back and forth 5,000 times with a denim fabric (Levi's 501) at a load of 500 g/cm². Then, the contact angle was measured by using pure water under the same conditions as described above.

Further, a solvent resistance test was conducted.

A nonwoven fabric (BEMLIESE made by ASAHI GLASS CO., LTD.) was impregnated with methyl ethyl ketone (MEK), and an initial hardcoat surface was rubbed back and forth 200 times with the MEK-impregnated non-woven fabric at a load of 250 g/cm². Then, the contact angle was measured by using pure water under the same conditions as described above.

### (Frictional Coefficient)

A hardcoat film was fixed on a horizontal test pedestal. Cowhide was laid on the hardcoat surface, and a load of 50 g was placed thereon. In this condition, the cowhide was drawn at a velocity of 500 mm/min in the horizontal direction by a tensile tester, and a coefficient of dynamic friction was calculated.

### (Evaluation of Fingerprint Resistance: Haze Value)

A haze value was measured by the following procedure using an artificial fingerprint liquid, and fingerprint resistance was evaluated. The lower the haze value of the surface on which the artificial fingerprint liquid is transferred, the better the fingerprint resistance can be evaluated.

### 1. Preparation of Artificial Fingerprint Liquid:

0.4 parts by weight of Kanto loam of class 11 testing powder 1 (median diameter: 1.6 to 2.3 μm) prescribed in JIS Z8901 as the fine-particle-form substance, 1 part by weight of triolein as the dispersion medium, and 10 parts by weight of methoxypropanol as the diluent were mixed and stirred to form an artificial fingerprint liquid.

### 2. Transfer of Artificial Fingerprint Liquid to the Surface of Hard Coat:

[1] While the artificial fingerprint liquid was sufficiently stirred with a magnetic stirrer, an approximately 1 mL portion of the liquid was collected. The collected liquid was applied onto a polycarbonate substrate (diameter: 120 mm, thickness: 1.2 mm) by spin coating. Spin coating was carried out at 500 rpm for 2 seconds, followed by 250 rpm for 2 seconds. This substrate was heated at 60° C. for 3 minutes to completely remove methoxypropanol, the diluent which had become unnecessary. In this way, a master plate for transferring pseudo-fingerprint patterns was obtained.

### [2] Transfer of Pseudo-Fingerprint Patterns to the Surface of Hard Coat

A No. 1 silicone rubber plug was uniformly rubbed with a #240 abrasive paper (having the performance equivalent to AA240 abrasive paper described in the JIS) on its smaller end surface (diameter: 12 mm) and was used as a pseudo-fingerprint transferring stamp. The rubbed end surface of the pseudo-fingerprint transferring stamp was pressed against the master plate with a load of 500 g for 10 seconds to transfer the artificial fingerprint liquid material to the end surface of the silicone rubber transferring stamp. Then, the end surface onto which the artificial fingerprint liquid material adhered was pressed against the hard coat surface of the hard coat film with a load of 500 g for 10 seconds to transfer the artificial fingerprint liquid material.

### 3. Measurement of Haze Value:

The haze value on the hard coat surface in the area in which the artificial fingerprint liquid material was transferred was measured by using a haze meter TC-HIII DPK (available from Tokyo Denshoku Co., Ltd.).

The operation for transferring the artificial fingerprint liquid is specifically described in International Publication WO2004/084206.

### (Curling Resistance)

On the base material surface of the hard coat film, an adhesive film of 25 μm thick having a separator attached to its back face (Oribain BPS-5296 made by TOYO INK CO., LTD.: 0.5 wt % of curing agent BXX4773 added) was pasted. This was then cut into a size of 10 cm×10 cm to form a measurement sample. For this measurement sample, heights of curling at four corners in relation to the center part were measured, and an average value thereof was determined. A smaller height of curling indicates smaller shrinkage by curing of the hard coat layer. The criteria for determination are as follows.

⊚: Almost no curling was observed

ο: Little but practically non-problematic level of curling was observed

X: Curling of practically problematic level was observed

### (Punchability)

On the base material surface of the hardcoat film, an adhesive film of 25 μm thick having a separator attached to its back face (Oribain BPS-5296 made by TOYO INK CO., LTD.: 0.5 wt % of curing agent BXX4773 added) was pasted. In this condition, the sample was punched with a pinnacle knife. Occurrences of crack and burr in the punched edge were observed by an optical microscope. The criteria for determination are as follows.

⊚: Neither crack nor burr was observed

ο: No crack and little burr were observed

Δ: Few cracks were observed

X: Many cracks were observed

In Tables 1-3, each numerical value in columns of A, B, C, D, E and F represents a blending composition (parts by weight) of each component of the hard coat agent.

TABLE 1

| | A | B | C | D | E | F | | | |
|---|---|---|---|---|---|---|---|---|---|
| | parts by | parts by | parts by | parts by | parts by | parts by | | Appear- | Haze value |
| | weght | weght | wehgt | weght | weght | weght | C/D | ance | (%) |
| Comparative | 80 | 20 | 0.00 | 0.70 | — | — | 0 | ◯ | 0.5 |
| Example 1 | | | | | | | | | |
| Comparative | 80 | 20 | 0.05 | 0.00 | — | — | — | — | — |
| Example 2 | | | | | | | | | |
| Comparative | 80 | 20 | 0.20 | 0.00 | — | — | — | — | — |
| Example 3 | | | | | | | | | |
| Comparative | 80 | 20 | 0.18 | 0.03 | — | — | 6.0 | X | — |
| Example 4 | | | | | | | | | |
| Comparative | 80 | 20 | 0.20 | 0.07 | — | — | 2.8 | X | — |
| Example 5 | | | | | | | | | |
| Comparative | 100 | 0 | 0.25 | 0.25 | — | — | 1.0 | ◯ | 0.5 |
| Example 6 | | | | | | | | | |
| Comparative | 80 | 20 | 0.05 | 0.50 | — | — | 0.1 | ◯ | 0.5 |
| Example 7 | | | | | | | | | |
| | Contact angle (deg) | | | | | | | | |
| | | | | | After | | Fingerprint | | |
| | | | After Steel | After | Solvent | | resistance | | |
| | Initial | Initial | wool test | Denim test | resistance | Friction | Haze value | Curling | |
| | Water | Triolein | Water | Water | test Water | coefficient | (%) | resistance | Punchability |
| Comparative | 109.0 | 72.5 | 78.5 | 88.5 | 66.0 | 0.95 | 1.1 | ◯ | ◯ |
| Example 1 | | | | | | | | | |
| Comparative | — | — | — | — | — | — | — | — | — |
| Example 2 | | | | | | | | | |
| Comparative | — | — | — | — | — | — | — | — | — |
| Example 3 | | | | | | | | | |
| Comparative | — | — | — | — | — | — | — | — | — |
| Example 4 | | | | | | | | | |
| Comparative | — | — | — | — | — | — | — | — | — |
| Example 5 | | | | | | | | | |
| Comparative | 108.5 | 72.0 | 108.0 | 107.5 | 108.0 | 0.80 | 1.3 | ◯ | Δ |
| Example 6 | | | | | | | | | |
| Comparative | 109.0 | 71.0 | 106.5 | 103.0 | 90.0 | 0.85 | 1.3 | ◯ | ⊚ |
| Example 7 | | | | | | | | | |

TABLE 2

| | A | B | C | D | E | F | | | |
|---|---|---|---|---|---|---|---|---|---|
| | parts by | parts by | parts by | parts by | parts by | parts by | | Appear- | Haze value |
| | weght | weght | wehgt | weght | weght | weght | C/D | ance | (%) |
| Example 1 | 80 | 20 | 0.05 | 0.02 | — | — | 2.5 | ◯ | 0.5 |
| Example 2 | 80 | 20 | 0.05 | 0.02 | 30 | — | 2.5 | ◯ | 0.5 |
| Example 3 | 80 | 20 | 0.10 | 0.05 | — | — | 2.0 | ◯ | 0.5 |
| Example 4 | 80 | 20 | 0.21 | 1.05 | — | — | 0.2 | ◯ | 0.5 |
| Example 5 | 80 | 20 | 0.23 | 0.46 | — | — | 0.5 | ◯ | 0.5 |
| Example 6 | 80 | 20 | 0.25 | 0.75 | — | — | 0.3 | ◯ | 0.6 |
| Example 7 | 80 | 20 | 0.34 | 0.17 | — | — | 2.0 | ◯ | 0.6 |
| Example 8 | 80 | 20 | 0.50 | 0.50 | — | — | 1.0 | ◯ | 0.7 |
| Example 9 | 80 | 20 | 0.50 | 0.50 | 60 | — | 1.0 | ◯ | 0.7 |
| Example 10 | 80 | 20 | 0.70 | 0.28 | — | — | 2.5 | ◯ | 1.0 |
| | Contact angle (deg) | | | | | | | | |
| | | | | | After | | Fingerprint | | |
| | | | After Steel | After | Solvent | | resistance | | |
| | Initial | Initial | wool test | Denim test | resistance | Friction | Haze value | Curling | |
| | Water | Triolein | Water | Water | test Water | coefficient | (%) | resistance | Punchability |
| Example 1 | 106.5 | 69.0 | 106.5 | 105.5 | 106.0 | 0.90 | 1.2 | ◯ | ⊚ |
| Example 2 | 106.5 | 69.5 | 106.0 | 105.5 | 106.0 | 0.90 | 1.2 | ⊚ | ◯ |
| Example 3 | 110.0 | 71.0 | 109.5 | 109.5 | 109.5 | 0.75 | 1.3 | ◯ | ⊚ |
| Example 4 | 110.5 | 72.5 | 109.5 | 110.0 | 109.5 | 0.75 | 1.1 | ◯ | ⊚ |
| Example 5 | 108.5 | 73.0 | 107.5 | 107.5 | 108.0 | 0.80 | 1.3 | ◯ | ⊚ |
| Example 6 | 109.0 | 71.5 | 108.5 | 108.0 | 108.5 | 0.80 | 1.2 | ◯ | ⊚ |
| Example 7 | 108.0 | 72.0 | 108.0 | 107.0 | 108.0 | 0.80 | 1.4 | ◯ | ⊚ |
| Example 8 | 108.5 | 73.0 | 108.5 | 109.0 | 108.0 | 0.80 | 1.2 | ◯ | ⊚ |
| Example 9 | 109.0 | 72.5 | 108.5 | 108.5 | 109.0 | 0.70 | 1.3 | ⊚ | ◯ |
| Example 10 | 109.5 | 71.5 | 109.0 | 109.0 | 109.0 | 0.75 | 1.3 | ◯ | ⊚ |

TABLE 3

| | A | B | C | D | E | F | | | |
|---|---|---|---|---|---|---|---|---|---|
| | parts by | parts by | parts by | parts by | parts by | parts by | | Appear- | Haze value |
| | weght | weght | wehgt | weght | weght | weght | C/D | ance | (%) |
| Comparative | 80 | 20 | 0.80 | 0.32 | 60 | — | 2.5 | X | 1.4 |
| Example 8 | | | | | | | | | |
| Comparative | 80 | 20 | 0.80 | 0.32 | — | — | 2.5 | X | 1.4 |
| Example 9 | | | | | | | | | |
| Comparative | 80 | 20 | 1.00 | 0.00 | — | — | — | — | — |
| Example 10 | | | | | | | | | |
| Comparative | 80 | 20 | 0.70 | 0.00 | — | — | — | — | — |
| Example 11 | | | | | | | | | |
| Comparative | 80 | 20 | 0.70 | 0.00 | 60 | 0.28 | 2.5 | ◯ | 1.1 |
| Example 12 | | | | | | | | | |
| Comparative | 80 | 20 | 0.70 | 0.00 | — | 0.28 | 2.5 | ◯ | 1.1 |
| Example 13 | | | | | | | | | |
| Comparative | 100 | 0 | 0.70 | 0.00 | 60 | 0.28 | 2.5 | ◯ | 0.6 |
| Example 14 | | | | | | | | | |
| | Contact angle (deg) | | | | | | | | |
| | | | | | After | | Fingerprint | | |
| | | | After Steel | After | Solvent | | resistance | | |
| | Initial | Initial | wool test | Denim test | resistance | Friction | Haze value | Curling | |
| | Water | Triolein | Water | Water | test Water | coefficient | (%) | resistance | Punchability |
| Comparative | 110.0 | 72.0 | 109.0 | 109.5 | 109.0 | 0.75 | 1.3 | ⊚ | ◯ |
| Example 8 | | | | | | | | | |
| Comparative | 110.0 | 71.0 | 109.5 | 109.5 | 110.0 | 0.75 | 1.3 | ◯ | ⊚ |
| Example 9 | | | | | | | | | |
| Comparative | — | — | — | — | — | — | — | — | — |
| Example 10 | | | | | | | | | |
| Comparative | — | — | — | — | — | — | — | — | — |
| Example 11 | | | | | | | | | |
| Comparative | 105.0 | 73.0 | 100.5 | 104.0 | 103.5 | 0.75 | 2.4 | ⊚ | Δ |
| Example 12 | | | | | | | | | |
| Comparative | 105.5 | 72.0 | 104.0 | 104.0 | 104.0 | 0.75 | 2.7 | ◯ | ◯ |
| Example 13 | | | | | | | | | |
| Comparative | 104.0 | 72.0 | 102.5 | 103.0 | 102.0 | 0.75 | 2.5 | ◯ | x |
| Example 14 | | | | | | | | | |

These measurement results are shown in Tables 1-3.

Table 2 demonstrates that all of hard coat films in Examples 1 to 10 are excellent in transparency and appearance, and are excellent in anti-staining property, lubricating property, solvent resistance, scratch resistance and abrasion resistance, as well as in punchability.

What is claimed is:

1. A hard coat agent composition comprising:
a urethane acrylate (B) having two or more (meth) acryloyl groups within each molecule and not containing fluorine;
a first fluorine-containing polyether compound (C) having an active energy ray reactive group via a urethane bond at each of both ends of a molecular chain containing a perfluoropolyether group;
a second fluorine-containing polyether compound (D) having an active energy ray reactive group via a urethane bond at one end of a molecular chain containing a perfluoropolyether group and not having an active energy ray reactive group at the other end; and
a curable compound (A) having two, or three or more active energy ray polymerizing groups within each molecule and not containing a urethane bond and fluorine, wherein
the (C) component is contained in an amount of 0.05 to 0.7 parts by weight in relation to 100 parts by weight of a total amount of the (A) component and the (B) component, and
the (D) component is contained so that a weight ratio C/D between the (C) component and the (D) component ranges from 1/5 to 5/2.

2. The hard coat agent composition according to claim 1, wherein the (B) component is contained in an amount of 5 to 50 parts by weight in relation to 100 parts by weight of the (A) component.

3. The hard coat agent composition according to claim 1, wherein the curable compound (A) contains 65 to 100% by weight of a curable compound (At) having three or more active energy ray polymerizing groups within each molecule, and 0 to 35% by weight of a curable compound (Ad) having two active energy ray polymerizing groups within each in the molecule on the basis of the curable compound (A).

4. The hard coat agent composition according to claim 1, wherein the active energy ray reactive group contained in the first fluorine-containing polyether compound (C) and/or the active energy ray reactive group contained in the second fluorine-containing polyether compound (D) are selected from the group consisting of a (meth)acryloyl group and a vinyl group.

5. The hard coat agent composition according to claim 1, wherein the active energy ray polymerizing groups contained in the curable compound (A) are selected from the group consisting of a (meth)acryloyl group and a vinyl group.

6. The hard coat agent composition according to claim 1, wherein the first fluorine-containing polyether compound (C) is a compound in which:
a (meth)acryloyl group is introduced via two urethane bonds derived from an diisocyanate compound into each of hydroxyl groups at both ends in a perfluoropolyether compound having a perfluoropolyether group and having a hydroxyl group at each of both ends.

7. The hard coat agent composition according to claim 6, wherein the diisocyanate compound is selected from the group consisting of an aliphatic diisocyanate and an alicyclic diisocyanate.

8. The hard coat agent composition according to claim 1, wherein the second fluorine-containing polyether compound (D) is a compound in which:
one hydroxyl group in a perfluoropolyether compound having a perfluoropolyether group and having a hydroxyl group at one end or both ends, and one isocyanate group in a triisocyanate compound which is a cyclic trimer of a diisocyanate form a urethane bond; and
one or two (meth)acryloyl group(s) is/are introduced via a urethane bond derived from the other one or two isocyanate group(s) in the triisocyanate compound.

9. The hard coat agent composition according to claim 8, wherein the diisocyanate compound forming the triisocyanate is selected from the group consisting of an aliphatic diisocyanate and an alicyclic diisocyanate.

10. The hard coat agent composition according to claim 1, further comprising inorganic fine particles (E) having an average particle diameter of 100 nm or less.

11. The hard coat agent composition according to claim 10, wherein the inorganic fine particles (E) are silica fine particles which may be surface-modified by a hydrolyzable silane compound having an active energy ray reactive group.

12. An article provided with a hard coat layer comprising a cured substance of the hard coat agent composition according to claim 1, on the surface of the article.

13. A hard coat film comprising a transparent base material and a hard coat layer on the transparent base material, wherein the hard coat layer comprises a cured substance of the hard coat agent composition according to claim 1.
